(19) United States
(12) Patent Application Publication
(10) Pub. No.: US 2016/0076902 A1
(43) Pub. Date: Mar. 17, 2016

(54) COLLOQUIAL OR USER-FAVORED ROUTE BASED NAVIGATION INSTRUCTIONS

(71) Applicant: Microsoft Corporation, Redmond, CA (US)

(72) Inventors: Ana Lilia Otero Diaz, Woodinville, WA (US); Yekaterina Grabar, Seattle, WA (US); Paul R. Nash, Bellevue, WA (US); Jeffrey Darren Couckuyt, Bothell, WA (US); Vishal Mishra, Sammamish, WA (US)

(21) Appl. No.: 14/485,445

(22) Filed: Sep. 12, 2014

(51) Int. Cl. G01C 21/36

(52) U.S. Cl. CPC G01C 21/3626; G01C 21/3641

(57) ABSTRACT

A route between start and destination locations is generated, and a navigation device presents navigation instructions to a user describing the route. The navigation instructions can be colloquial navigation instructions, which are instructions that are more humanized (e.g., more conversational in language and format, or consistent with the manner in which people typically talk to one another in familiar or informal conversation). The route that is generated can be based on one or more user-favored routes. A user-favored route is a route between two locations that is determined to be desired, preferred, or otherwise favored by a user over other routes. The route that is generated can be generated to include at least part of one or more user-favored routes.

### BACKGROUND

As computing technology has advanced, people have come to increasingly rely on their computing devices for various functionality. One type of functionality people rely on is navigation, such as using dedicated devices or their smartphones to receive instructions in their car to navigate to a destination. Although such functionality is very useful, it is not without its problems. One such problem is that the navigation functionality oftentimes provides instructions that are difficult for users to fully comprehend, or that require additional thought or attention by the user to comprehend, which can be frustrating for users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a navigation device a route between a start location and a destination location is generated. Colloquial navigation instructions describing at least part of the route are identified by analyzing the route and are presented, the colloquial navigation instructions identifying a number of blocks in situations in which locations of roads along the route correspond to city blocks.

In accordance with one or more aspects, in a navigation device a request for a route between a start location and a destination location is received and one or more user-favored routes of a user of the navigation device are identified. A route between the start location and the destination location is generated based on the start location, the destination location, and the one or more user-favored routes, and navigation instructions for the route are presented.

In accordance with one or more aspects, a navigation device includes a global navigation satellite system, a user-favored route based route identification module, and a colloquial instruction generation module. The global navigation satellite system, implemented at least in part in hardware, is configured to determine a position of the navigation device. The user-favored route based route identification module is configured to receive a request for a route between a start location and a destination location, identify one or more user-favored routes of a user of the navigation device, and generate, based on the start location, the destination location, and the one or more user-favored routes, a route between the start location and the destination location. The colloquial instruction generation module is configured to identify, by analyzing the route, colloquial navigation instructions describing at least part of the route, and play back the colloquial navigation instructions audibly as the user travels along the route.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example navigation device implementing the colloquial or user-favored route based navigation instructions in accordance with one or more embodiments.

FIG. 2 is a flowchart illustrating an example process for generating and presenting colloquial navigation instructions in accordance with one or more embodiments.

FIG. 3 illustrates an example of a route and map-related features along the route in accordance with one or more embodiments.

FIG. 4 illustrates an example user interface presenting colloquial navigation instructions in accordance with one or more embodiments.

FIG. 5 illustrates an example user interface presenting colloquial navigation instructions and visual aids in accordance with one or more embodiments.

FIG. 6 is a flowchart illustrating an example process for generating routes that are based on one or more other user-favored routes in accordance with one or more embodiments.

FIGS. 7A, 7B, and 7C illustrate an example of generating a route based on one or more user-favored routes in accordance with one or more embodiments.

FIG. 8 illustrates an example user interface that can be displayed to a user of a device to allow the user to select whether position data for that device will be recorded in accordance with one or more embodiments.

FIG. 9 illustrates an example system that includes an example computing device that is representative of one or more systems and/or devices that may implement the various techniques described herein.

### DETAILED DESCRIPTION

Colloquial or user-favored route based navigation instructions are discussed herein. A route between start and destination locations is generated, and navigation instructions are presented to the user as he or she travels along the route. The navigation instructions can be colloquial navigation instructions, which refer to instructions that are humanized (consistent in language and format with the manner in which people typically talk to one another in familiar or informal conversation). For example, rather than an instruction to “turn left in 200 meters”, a colloquial instruction would be to “turn left in 3 blocks”, or “turn right at the second stoplight”. The presentation of colloquial navigation instructions advantageously improves usability of a navigation device by providing navigation instructions that are more consistent with informal conversation and that can typically be comprehended more quickly by the user. For example, users are typically able to more quickly comprehend how far 3 blocks is than 200 meters.

Additionally or alternatively, the route that is generated can be based on one or more user-favored routes. A user-favored route refers to a route between two locations that is determined to be desired, preferred, or otherwise favored by the user over other routes. The route that is generated can be generated to include at least part of one or more user-favored routes. Generation of the route to include at least part of one or more user-favored routes advantageously improves usability of a navigation device by providing a route that includes portions of other routes that the user is familiar with, prefers, or otherwise desires or favors.

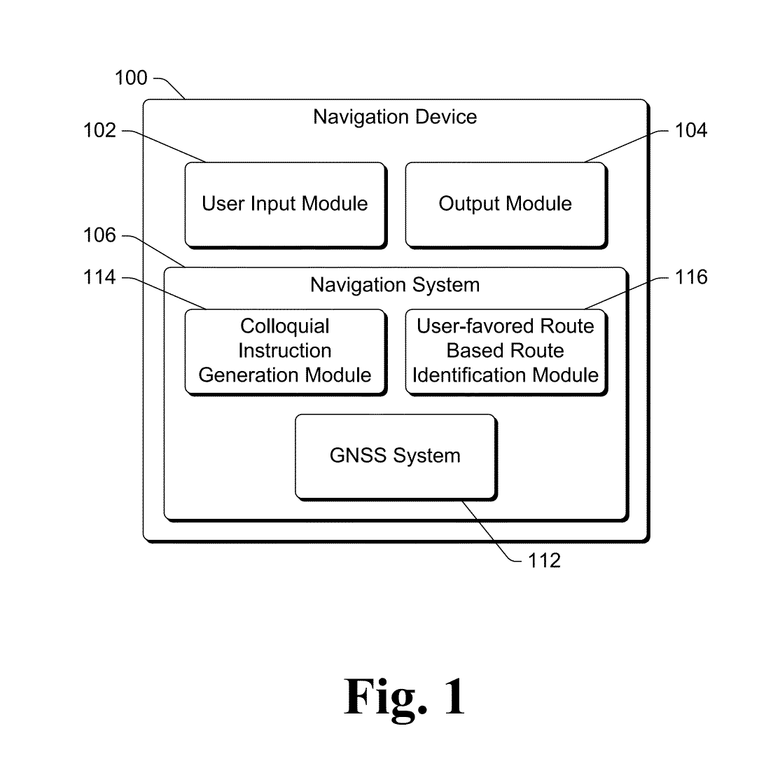

FIG. 1 is a block diagram illustrating an example navigation device 100 implementing the colloquial or user-favored route based navigation instructions in accordance with one or more embodiments. Navigation device 100 can be a variety of different types of devices, such as a cellular or other wireless phone (e.g., a smartphone), a laptop or netbook computer, a tablet or notepad computer, a phablet computer, a wearable device (e.g., eyeglasses, watch), a mobile station, an entertainment appliance, a dedicated or standalone navigation device, an automotive computer, and so forth. Thus, navigation device 100 may range from full resource devices with substantial memory and processor resources (e.g., laptop computers, tablet computers) to low-resource devices with limited memory and/or processing resources (e.g., dedicated or standalone navigation devices).

Navigation device 100 includes a user input module 102, an output module 104, and a navigation system 106. The user input module 102 receives user inputs from a user of the navigation device 100. User inputs can be provided in a variety of different manners, such as by pressing one or more keys of a keypad or keyboard of the device 100, pressing a particular portion of a touchpad or touchscreen of the device 100, making a particular gesture on a touchpad or touchscreen of the device 100, an action that can be recognized by a motion detection or other component of the device 100 (such as shaking the device 100, rotating the device 100, bending or flexing the device 100, etc.), combinations thereof, and so forth. User inputs can also be provided in other manners, such as via voice or other audible inputs to a microphone, via motions of hands or other body parts observed by an image capture device, and so forth.

The output module 104 generates, manages, and/or outputs content for display, playback, and/or other presentation. This content can be created by the output module 104 or obtained from other modules of the navigation device 100. This content can be, for example, a display or audible playback portion of navigation instructions to a particular destination. The content can be displayed or otherwise played back by components of the navigation device 100 (e.g., speakers, interactive display devices, etc.). Alternatively, the output module 104 can generate one or more signals that are output to other devices or components (e.g., speakers, display devices, etc.) that are separate from the navigation device 100 (e.g., speakers in a vehicle in which the navigation device 100 is situated).

The navigation system 106 includes a Global Navigation Satellite System (GNSS) system 112, a colloquial instruction generation module 114, and a user-favored route based route identification module 116. The GNSS system 112 implements GNSS functionality for the device 100, determining a geographic position of the device 100 based on one or more satellites from which the GNSS system 112 can receive signals or otherwise communicate. This determined position is typically latitude and longitude coordinates, although the position can alternatively be specified in other manners. The GNSS system 112 can implement the GNSS functionality using a variety of different technologies, such as the Global Positioning System (GPS), the Global Navigation Satellite System (GLONASS), the BeiDou (or Compass) navigation system, the Galileo positioning system, combinations thereof, and so forth. Although illustrated as part of the navigation device 100, the GNSS system 112 can alternatively be situated at least in part separate from the navigation device 100. For example, one or more components of the GNSS system 112 can be implemented by a vehicle in which the navigation device 100 is situated.

The colloquial instruction generation module 114 generates colloquial navigation instructions. Navigation instructions (also referred to herein as simply instructions) refer to the information presented by the navigation system 106 along the route to the destination. Colloquial navigation instructions (also referred to as simply colloquial instructions) refer to navigation instructions that are humanized—instructions that are conversational or use language and formats that are consistent with the manner in which people typically converse with one another in familiar or informal conversation. For example, rather than an instruction to turn in 300 meters, a colloquial instruction would be to turn in 3 blocks, or turn at the second stoplight.

The navigation instructions, whether colloquial navigation instructions or non-colloquial navigation instructions, include directional guidance to direct a user to the destination, such as information regarding which roads to turn onto, which exits to take, how long until a turn is to be made, directions to make turns, and so forth. The instructions can be presented audibly or in other manners.

The user-favored route based route identification module 116 identifies routes from start locations to destination locations (also referred to as simply the start or destination). The routes are identified based on user-favored routes. A user-favored route refers to a route between two locations that is determined to be desired, preferred, or otherwise favored by a user of the navigation device 100 over other routes. Favorite routes of the user can be specified by the user (e.g., saved in a “favorites” list) or in other manners as discussed in more detail below.

The techniques discussed herein can apply to various different modes of transportation, such as walking, bicycling, vehicle (e.g., in a car or truck), mass transit, and so forth. Although references may be made herein to particular modes of transportation (e.g., roads or driving), it should be noted that the techniques discussed with such references apply analogously to other modes of transportation and other types of paths (e.g., sidewalks or bike paths rather than roads).

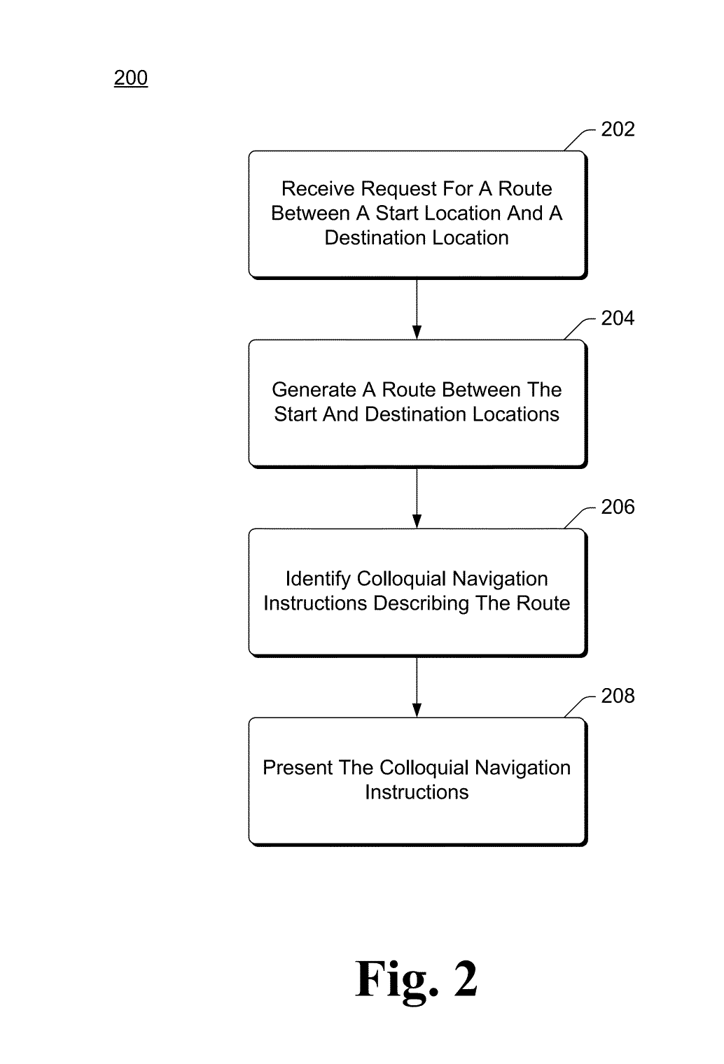

FIG. 2 is a flowchart illustrating an example process 200 for generating and presenting colloquial navigation instructions in accordance with one or more embodiments. Process 200 is carried out by a device, such as navigation device 100 of FIG. 1, and can be implemented in software, firmware, hardware, or combinations thereof. Process 200 is shown as a set of acts and is not limited to the order shown for performing the operations of the various acts. Process 200 is an example process for generating and presenting colloquial navigation instructions; additional discussions of generating and presenting colloquial navigation instructions are included herein with reference to different figures.

In process 200, a request for a route between a start location and a destination location is received (act 202). The request can be received as a user input, or alternatively the request can be received from another component, module, device, and so forth. The start location is typically a current location of the navigation device 100, but can alternatively be other locations. The start and destination locations each refer to any geographic position, and can be identified in any of a variety of different manners. For example, a start or destination location can be identified by a user input (e.g., a user input entering an address, selecting a stored or favorite address), by an indication from another component, module, or device, and so forth.

A route between the start location and the destination location is determined (act 204). The route can be determined using any of a variety of public or proprietary techniques. The route determined in act 204 can optionally be based on one or more user-favored routes as discussed in more detail below, but need not be based on any user-favored routes.

Colloquial navigation instructions describing the determined route are identified (act 206). As discussed above, colloquial navigation instructions are instructions that are consistent with the manner in which people typically talk to one another in familiar or informal conversation. By way of example, colloquial navigation instructions give distances in units that people typically give instructions in (e.g., a number of city blocks, a number of intersections), whereas non-colloquial navigation instructions give distances in more formal units (e.g., meters, feet). Generally, the colloquial navigation instructions are generated by analyzing the route and identifying one or more colloquial navigation instructions for presentation (e.g., as the user travels along the route). Colloquial navigation instructions for presentation for the entire route can be generated, or alternatively colloquial navigation instructions for presentation for one or more parts of the route can be generated (and non-colloquial navigation instructions (e.g., turn right in 300 meters) can be generated for presentation for other parts of the route).

Colloquial navigation instructions can be generated based on personalization, map characteristics, combinations thereof, and so forth. Personalization refers to using landmarks as a basis for navigation instructions. The navigation system maintains or has access to a set of landmarks and their locations (e.g., geographic coordinates or other location identifiers). A landmark refers to a structure, geological formation, or other object readily identifiable by users. The set of landmarks can include global landmarks, personal landmarks, or a combination thereof. A global landmark refers to a landmark that most people (e.g., at least a threshold number of people) familiar with an area would know, such as the location of main chain stores or services, transit landmarks (e.g., bus stops or train stations), unique structures, and so forth. For example, global landmarks can include the Empire State Building, Bellevue Square shopping center, the Louvre Museum, King's Cross railway station, and so forth. A personal landmark refers to a landmark that the user is expected to know even if other people familiar with an area may not know the landmark. For example, personal landmarks can be a friend's house, a family member's house, a building where the user works, a store that the user shops at regularly, a theater that the user has been to at least a threshold number of times, and so forth.

The colloquial navigation instructions can refer to one or more of these landmarks, identifying one or more landmarks rather than distances or other instructions. For example, assume that a route involves traveling along a 2-kilometer stretch of road the passes the Louvre Museum. Rather than presenting an instruction of “stay on this road for 2 kilometers”, a colloquial navigation instruction can be generated that is “stay on this road and pass the Louvre Museum”. By way of another example, assume that a route involves turning left on a particular street, and that a theater (e.g., the 5^{th} Avenue Theatre) that the user regularly attends is on the corner where the left turn occurs. Rather than presenting an instruction of “turn left in 300 meters”, a colloquial navigation instruction can be generated that is “turn left at the 5^{th} Avenue Theatre”.

Map characteristics refer to features along the route that are related to a map of the geographic area that includes the route. These map-related features can be, for example, the layout of roads or other travel paths (e.g., train tracks or other railways, sidewalks or bike paths), locations of buildings, locations of geographic features (e.g., streams or rivers), locations of bridges or other roadway structures, and so forth. In one or more embodiments, the colloquial instruction generation module analyzes the route and determines one or more map-related features along the route that can be used for colloquial instructions.

The analysis of a route to determine map-related features can be performed in a variety of different manners, and is based at least in part on the information available in the map. The information available in the map can include information that is displayed when the map is displayed (e.g., locations of roads and buildings) as well as information that may not be displayed when the map is displayed (e.g., speed limits). Different information or data can be included in the map, this information or data describing various characteristics of the geographic area described by the map. For example, in situations in which the map includes the locations of stoplights, the location of stoplights along the route can be analyzed and colloquial navigation instructions generated based on those locations. By way of another example, in situations in which the map includes the locations of roads, the location of roads along the route can be analyzed and colloquial navigation instructions generated based on those locations.

In one or more embodiments, the colloquial instruction generation module analyzes the locations of roads along the route to determine whether the locations of the roads correspond to city blocks (also referred to as simply blocks). If the locations of roads along a particular part of the route correspond to city blocks, then colloquial navigation instructions that refer to city blocks (e.g., “turn right in 3 blocks”) are generated for that particular part of the route. A number of cross-roads between two locations, which corresponds to a number of city blocks between those two locations, can be readily determined and used as the number of blocks to identify in the colloquial navigation instructions. However, if the locations of roads along the particular part do not correspond to city blocks, then colloquial navigation instructions that refer to city blocks are not generated for that particular part of the route.

Whether the locations of the roads along a particular part of a route correspond to city blocks can be determined by analyzing various characteristics of the locations of the roads. Roads that are laid out in a city block configuration have certain characteristics, such as having cross-roads located at particular intervals (e.g., at least a first threshold distance between roads but less than a second threshold distance between roads), having particular speed limits (e.g., less than a threshold speed limit), having cross-roads intersect approximately (e.g., within a threshold number of degrees of) perpendicularly, and so forth. If the characteristics of the locations of the roads along a particular part of the route correspond to (e.g., match or are the same as) characteristics of roads that are laid out in a city block configuration, then the locations of the roads along the particular part of the route are determined to correspond to city blocks.

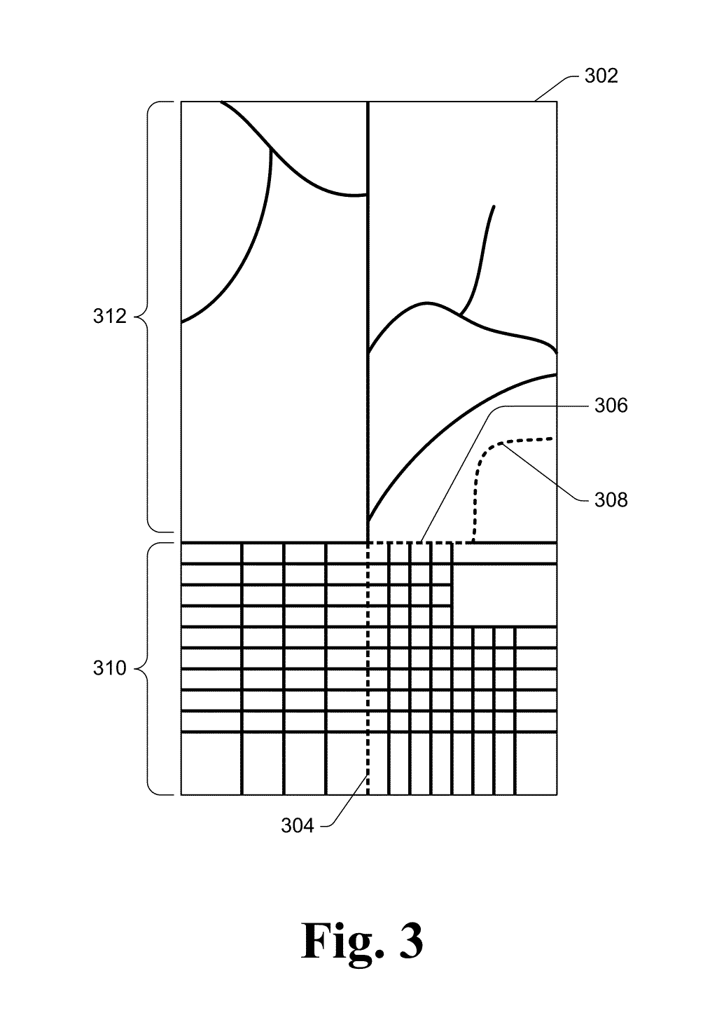

FIG. 3 illustrates an example of a route and map-related features along the route in accordance with one or more embodiments. FIG. 3 illustrates a map 302 having multiple different roads, each illustrated as a line in the map 302. The route passes through the geographic area described by the map 302 along the roads 304, 306, and 308, each illustrated as a dashed line in FIG. 3. For one part of the route, shown as part 310, the characteristics of the locations of the roads along the route correspond to characteristics of roads that are laid out in a city block configuration. Thus, colloquial navigation instructions that refer to city blocks (e.g., “turn right in 3 blocks”) are generated for the part 310 of the route. However, for another part of the route, shown as part 312, the characteristics of the locations of the roads along the route do not correspond to characteristics of roads that are laid out in a city block configuration. Thus, colloquial navigation instructions that refer to city blocks (e.g., “turn right in 3 blocks”) are not generated for the part 312 of the route. Rather, other colloquial navigation instructions or non-colloquial navigation instructions can be generated for the part 312.

Returning to FIG. 2, in one or more embodiments the colloquial instruction generation module analyzes the locations of stoplights (also referred to as traffic control signals or traffic lights) along the route. A number of stoplights between two locations can be readily determined and used in the colloquial navigation instructions (e.g., “turn right at the second stoplight”).

Additionally, or alternatively, the colloquial instruction generation module can analyze the locations of various other map-related features along the route. A number of any one or more of these various other map-related features between two locations can be readily determined and used in colloquial navigation instructions. These various other map-related features can include, for example, locations of bodies of water (e.g., rivers, streams, lakes), locations of bridges, locations of stop signs (or other traffic control signs), locations of other pathways (e.g., sidewalks, bike paths, alleyways, etc.), locations of traffic circles or roundabouts, locations of one-way streets, locations of dead-end streets, locations of particular types or classes of roads (e.g., highways, boulevards, 2-lane roads, 4-lane roads, etc.), locations of off-ramps or on-ramps, locations of driveways, locations of buildings, descriptions of buildings (e.g., color, height, material (e.g., glass and steel, brick), etc.), and so forth. This analysis can lead to various different colloquial navigation instructions, such as “turn left after the river”, “turn right before the bridge”, “turn left at the second stop sign”, “turn left on the first street after the alley”, “turn into the third driveway on the right”, “turn left after the fourth building”, “turn right after the pink building”, and so forth.

Thus, in one or more embodiments, the colloquial navigation instructions are navigation instructions that include or reference a landmark as discussed above, a map-related feature as discussed above, or combination thereof. Further, in such embodiments the colloquial navigation instructions are navigation instructions that include or reference such a landmark and/or map-related feature rather than a distance given in a more formal unit (e.g., units of measure in the metric system such as meters or kilometers, or units of measure in US customary units such as yards or miles).

The colloquial navigation instructions identified in act 206 are presented (act 208). The colloquial navigation instructions can be presented at various times, such as while the user travels along the route, prior to the user beginning travel along the route, and so forth. The colloquial navigation instructions can also be presented without the user traveling along the route (e.g., for the user to review regardless of whether he or she travels along the route). The colloquial navigation instructions can be played back audibly or alternatively can be presented in other manners.

The colloquial navigation instructions can be presented in act 208 in place of non-colloquial instructions describing the route, or alternatively in conjunction with non-colloquial instructions describing the route. For example, the colloquial instruction of “in 3 blocks turn right onto 156^{th} Avenue” can be presented in place of, or in conjunction with, the non-colloquial instruction of “in 300 meters turn right”.

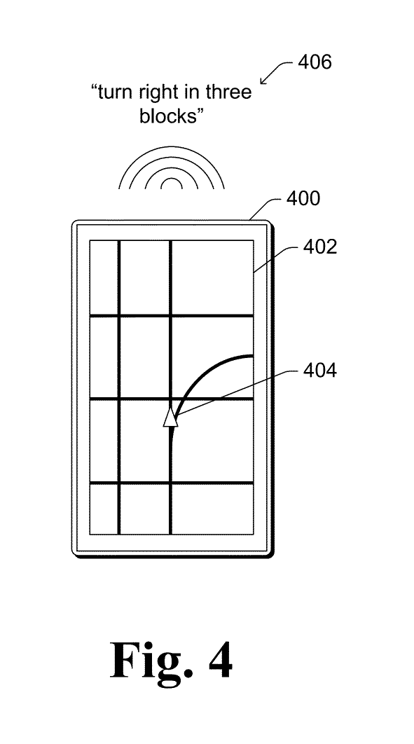

FIG. 4 illustrates an example user interface presenting colloquial navigation instructions in accordance with one or more embodiments. FIG. 4 includes a navigation device 400, which can be a navigation device 100 of FIG. 1. A map 402 is displayed by the navigation device 400, including various streets and an arrow 404 indicating a current location of the user. An audible colloquial navigation instruction 406 is played back to the user, instructing the user to “turn right in three blocks”. The usability of the navigation device 400 is advantageously improved because the user is presented with colloquial instructions rather than more computerized instructions (e.g., turn right in 100 meters).

Returning to FIG. 2, in addition to or in place of audible colloquial navigation instructions, various different colloquial navigation instructions can be displayed by the navigation device in act 208. The colloquial navigation instructions can be, for example, text versions of the audible colloquial navigation instructions (e.g., displaying the phrase “turn right in three blocks”). The colloquial navigation instructions can be displayed on a screen or other display device, can be printed out on paper or other hard copy made, and so forth.

Various additional visual aids can also be displayed to emphasize or identify colloquial navigation instruction. These visual aids can be, for example, a display of particular characteristics of a building, landmark, or other structure. The visual aids need not be photo-realistic, but nonetheless can identify the characteristic. For example, if a building is situated at a corner where the route indicates a right turn is to be made, and the building has particular characteristics (e.g., is pink in color), those characteristics can be displayed by the navigation device. For example, the building on the corner can be displayed by the navigation device as pink.

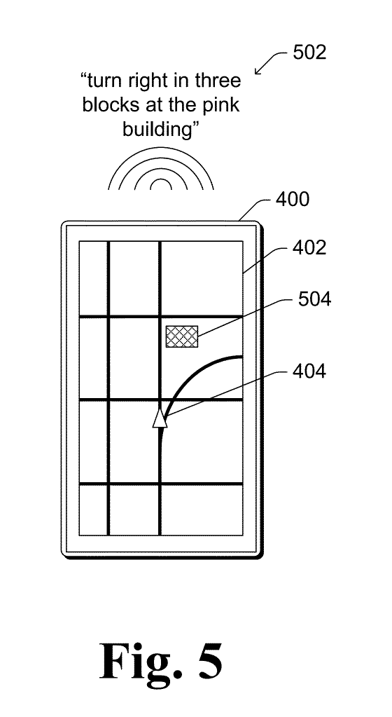

FIG. 5 illustrates an example user interface presenting colloquial navigation instructions and visual aids in accordance with one or more embodiments. FIG. 5 is similar to FIG. 4, and includes a navigation device 400, a map 402 including various streets and an arrow 404 indicating a current location of the user. FIG. 5 differs from FIG. 4, however, in that a different audible colloquial navigation instruction 502 is played back to the user (“turn right in three blocks at the pink building”), and a visual aid 504 is displayed in FIG. 5. The visual aid 504 is a building on the map displayed with the characteristics of the building (e.g., displayed as pink) as indicated by the cross-hatching of visual aid 504. The usability of the navigation device 500 is advantageously improved because the user is presented with colloquial instructions rather than more computerized instructions, and visual aids that reinforce the colloquial instructions are also displayed to the user.

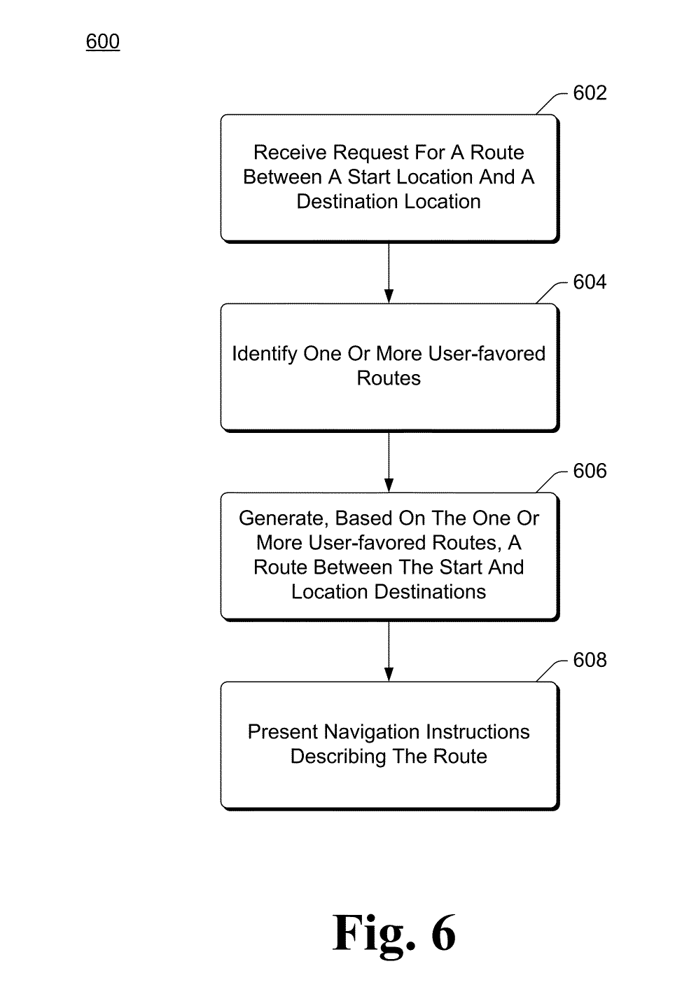

FIG. 6 is a flowchart illustrating an example process 600 for generating routes that are based on one or more other user-favored routes in accordance with one or more embodiments. Process 600 is carried out by a device, such as navigation device 100 of FIG. 1, and can be implemented in software, firmware, hardware, or combinations thereof. Process 600 is shown as a set of acts and is not limited to the order shown for performing the operations of the various acts. Process 600 is an example process for generating routes that are based on one or more other user-favored routes; additional discussions of generating routes that are based on one or more other user-favored routes are included herein with reference to different figures.

In process 600, a request for a route between a start location and a destination location is received (act 602). The request can be received as a user input, or alternatively the request can be received from another component, module, device, and so forth. The start location is typically a current location of the navigation device 100, but can alternatively be other locations. The start and destination locations each refer to any geographic position, and can be identified in any of a variety of different manners. For example, a start or destination location can be identified by a user input (e.g., a user input entering an address, selecting a stored or favorite address), by an indication from another component, module, or device, and so forth.

One or more user-favored routes are identified (act 604). A user-favored route refers to a route between two locations that is determined to be desired, preferred, or otherwise favored over other routes. Which routes are user-favored routes can be determined in a variety of different manners. In one or more embodiments, a user input is received identifying a route as a user-favored route. The user input can be any of a variety of different user inputs as discussed above. Whenever a route is generated by the navigation device, a user input can be received to identify the route as user-favored. For example, the user can provide a user input to save the route to a “favorites” list, a user input to star or “like” the route, and so forth.

Additionally or alternatively, user-favored routes can be determined automatically by a component or module (e.g., by a module of the navigation system 106). User-favored routes can be determined automatically in a variety of different manners. For example, a route that is taken between start and destination locations at least a threshold number of times (or at least a threshold percentage of the number of times the user travels between the start and destination locations) can be automatically determined to be a user-favored route. By way of another example, a route that is taken between start and destination locations that is different than the route generated by the navigation device can be automatically determined to be a user-favored route.

A route between the start and location destinations (as indicated in act 602) is generated based on the identified one or more user-favored routes (act 606). The generated route in act 606 is effectively “snapped to” a user-favored route, using at least part of a user-favored route. This route generation based on one or more user-favored routes advantageously improves usability of the navigation device by allowing a user to have a route generated in act 606 that includes portions of one or more other routes that the user is familiar with, prefers, or otherwise desires or favors.

The generation of a route based on one or more user-favored routes can be performed in various manners. Situations oftentimes arise in which multiple different routes can be generated between the start and destination locations, these multiple different routes having minor differences in travel times or travel distances. In such situations, the route having the most parts (e.g., the longest travel time along, or the longest distance) in common with a user-favored route is the route generated in act 606. For example, if a first route indicates 15 minutes travel time (e.g., based on the speed limit(s) along the route) along one or more user-favored routes and a second route indicates 25 minutes travel time along one or more user-favored routes, then the second route is the route generated in act 606. By way of another example, if a first route includes 5 kilometers along one or more user-favored routes and a second route includes 10 kilometers along one or more user-favored routes, then the second route is the route generated in act 606.

Additionally, situations can arise in which a route can be generated between the start and destination locations, and the route passes near (e.g., within a threshold distance of, such as within one kilometer of) a part of a user-favored route. In such situations, the route being generated can be changed so that the route does include that part of the user-favored route. In one or more embodiments, the route is changed only if the change would result in at least a threshold amount of time or distance (e.g., at least five minutes, at least two times the threshold distance used to determine whether the route passes near part of a user-favored route, etc.) along the user-favored route.

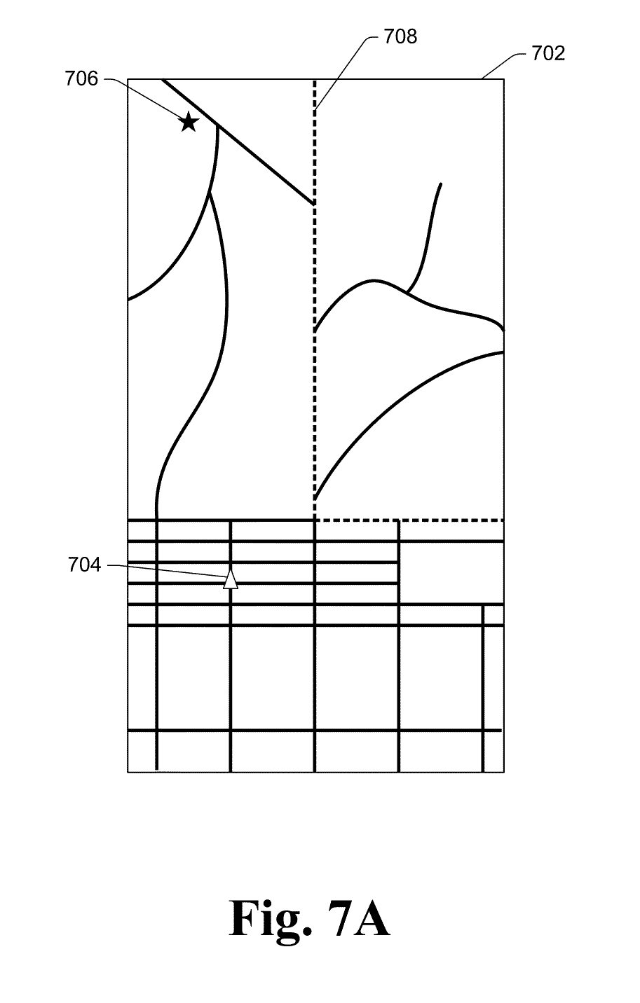

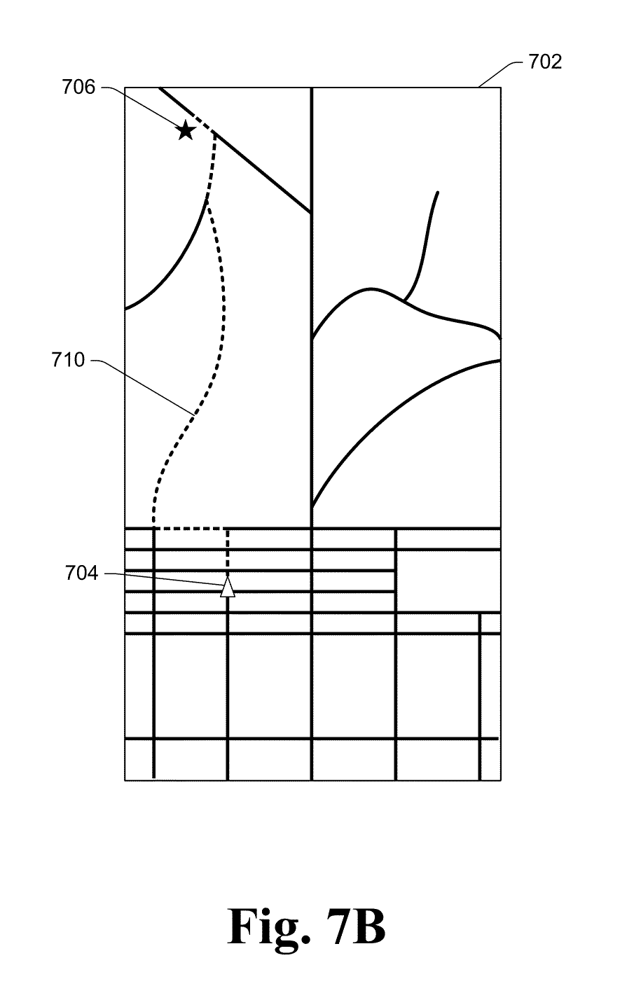

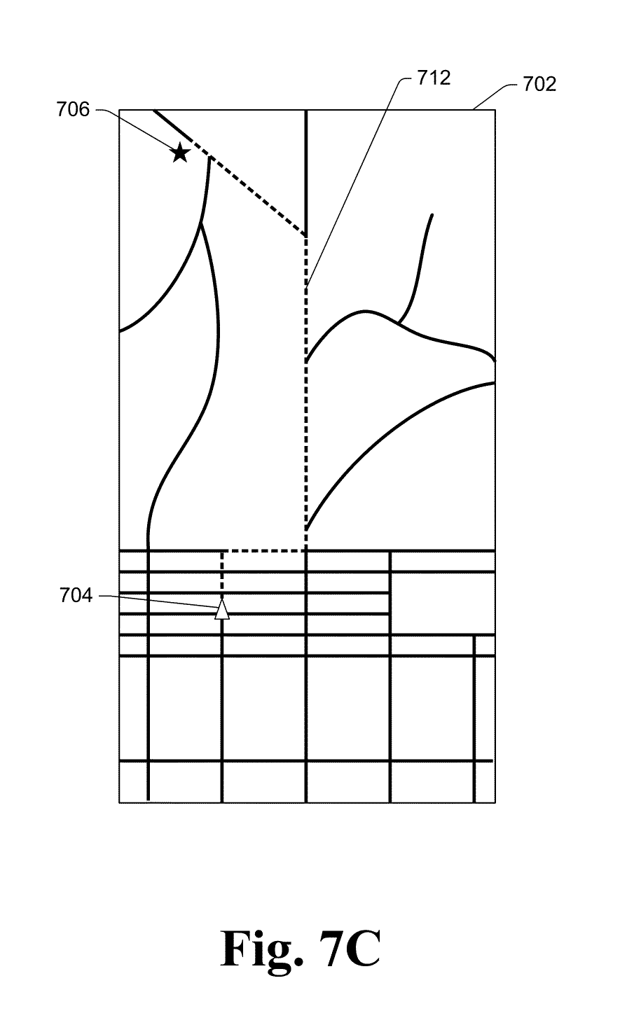

FIGS. 7A, 7B, and 7C illustrate an example of generating a route based on one or more user-favored routes in accordance with one or more embodiments. FIGS. 7A, 7B, and 7C each illustrate a map 702 having multiple different roads, each illustrated as a line in the map 702. An arrow 704 identifies a start location for a route to be generated, and a star 706 identifies a destination location for the route to be generated.

Assume that a user-favored route between another start location and another destination route includes various roads in the map 702, illustrated by the dashed line 708 in FIG. 7A. In generating the route from the arrow 704 to the star 706, a first route illustrated by dashed line 710 in FIG. 7B could be generated, or a second route illustrated by dashed line 712 in FIG. 7C could be generated. The route illustrated by the dashed line 712 in FIG. 7C is the route generated in act 606 because the route illustrated by the dashed line 712 in FIG. 7C is the one of the two routes that includes the most parts in the user-favored route illustrated by the dashed line 708 in FIG. 7A.

Returning to FIG. 6, navigation instructions for the route generated in act 606 are presented (act 608). The navigation instructions can be presented at various times, such as while the user travels along the route, prior to the user beginning travel along the route, and so forth. The navigation instructions can also be presented without the user traveling along the route (e.g., for the user to review regardless of whether he or she travels along the route). The navigation instructions can be presented in different manners, such as by being played back audibly, being displayed on a screen or other display device, being printed out on paper or other hard copy made, and so forth.

Processes 200 and 600 are illustrated as separate flowcharts in FIGS. 2 and 6. It should be noted that the embodiments described in FIGS. 2 and 6 can be used individually or alternatively in combination. For example, act 204 of FIG. 2 can be implemented as acts 604 and 606 of FIG. 6. E.g., the route generated in act 204 of FIG. 2 can be generated by identifying one or more user-favored routes in act 604 and generating a route between the start and location destinations based on the identified one or more user-favored routes in act 606.

Returning to FIG. 1, in one more embodiments, the user-favored route based route identification module 116 records various data indicating the position of the navigation device 100 at various times to be used in various manners, such as to identify user-favored routes as discussed above, personal landmarks as discussed above, and so forth. The recording of data indicating the position of the device 100 is performed after receiving user consent to do so. This user consent can be an opt-in consent, where the user takes an affirmative action to request that the position data be recorded before the navigation device 100 performs any recording of data for the device 100. Alternatively, this user consent can be an opt-out consent, where the user takes an affirmative action to request that the position data not be recorded; if the user does not choose to opt out of this recording of the position data, then it is an implied consent by the user to record the position data.

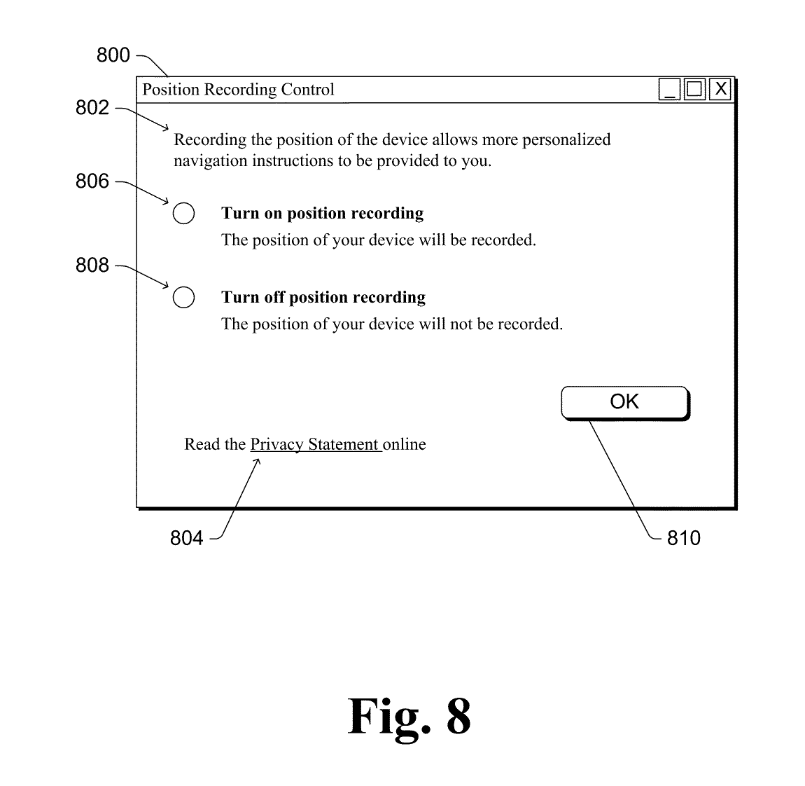

FIG. 8 illustrates an example user interface that can be displayed to a user of a device to allow the user to select whether position data for that device will be recorded in accordance with one or more embodiments. A position recording control window 800 is displayed including a description 802 explaining to the user why the position of the device is being recorded. A link 804 to a privacy statement is also displayed. If the user selects link 804, a privacy statement is displayed, explaining to the user how the recorded position data is kept confidential.

Additionally, the user is able to select a radio button 806 to opt-in to the position recording, or a radio button 808 to opt-out of the position recording. Once a radio button 806 or 808 is selected, the user can select an “OK” button 810 to have the selection saved. It is to be appreciated that radio buttons and an “OK” button are only examples of user interfaces that can be presented to a user to opt-in or opt-out of the position recording, and that a variety of other conventional user interface techniques can alternatively be used. The device then proceeds to record or not record the device position in accordance with the user's selection.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

In the discussions herein, various different embodiments are described. It is to be appreciated and understood that each embodiment described herein can be used on its own or in connection with one or more other embodiments described herein.

Further aspects of the techniques discussed herein relate to one or more of the following embodiments.

A method implemented in a navigation device comprises generating a route between a start location and a destination location; identifying, by analyzing the route, colloquial navigation instructions describing at least part of the route, the colloquial navigation instructions identifying a number of blocks in situations in which locations of roads along the route correspond to city blocks; and presenting the colloquial navigation instructions.

In the above described method, the identifying further includes: analyzing the route to identify map-related features along the route; and identifying the colloquial navigation instructions based at least in part on the map-related features.

In any one or more of the above described methods, the map-related features comprise the locations of roads, the analyzing includes determining based on the locations of roads that the locations of roads along a particular part of the route correspond to city blocks, and the colloquial navigation instructions identify a number of blocks until a turn is to be made.

In any one or more of the above described methods, the map-related features comprise locations of stoplights, and the colloquial navigation instructions identify a number of stoplights until a turn is to be made.

In any one or more of the above described methods, the map-related features comprise one or more features selected from the following: locations of bodies of water, locations of bridges, locations of driveways, locations of buildings, locations of off-ramps, and locations of on-ramps.

In any one or more of the above described methods, the identifying further includes analyzing the route to identify one or more landmarks along the route; and identifying the colloquial navigation instructions based at least in part on the landmarks along the route.

In any one or more of the above described methods, the one or more landmarks include a global landmark known to people familiar with the geographic area that includes the route.

In any one or more of the above described methods, the one or more landmarks include a personal landmark known to a user of the navigation device despite not being generally known by people familiar with the geographic area that includes the route.

In any one or more of the above described methods, the presenting the colloquial navigation instructions comprises playing back the colloquial navigation instructions audibly, and the method further comprises displaying a visual aid on a map that includes the route, the visual aid being an indication of one or more characteristics of a structure referred to in a colloquial navigation instruction.

In any one or more of the above described methods, the displaying the visual aid comprises displaying a structure on the map with a color of the structure as indicated by the one or more characteristics of the structure.

In any one or more of the above described methods, the generating the route comprises identifying one or more user-favored routes of a user of the navigation device; and generating, based on the start location, the destination location, and the one or more user-favored routes, a route between the start location and the destination location.

A method implemented in a navigation device comprises receiving a request for a route between a start location and a destination location; identifying one or more user-favored routes of a user of the navigation device; generating, based on the start location, the destination location, and the one or more user-favored routes, a route between the start location and the destination location; and presenting navigation instructions for the route.

In any one or more of the above described methods, the navigation instructions comprise colloquial navigation instructions, and the presenting comprises playing back the colloquial navigation instructions audibly.

In any one or more of the above described methods, the method further comprising receiving a user input indicating that a particular route is favored by the user; and saving, in response to the user input, an indication that the particular route is a user-favored route of the user.

In any one or more of the above described methods, the method further comprising automatically determining that a particular route is favored by the user; and saving, in response to the user input, an indication that the particular route is a user-favored route of the user.

In any one or more of the above described methods, the generating comprises identifying multiple different routes between the start location and the destination location; and selecting, as the route between the start location and the destination location, one of the multiple different routes having a largest number of parts in common with one of the one or more user-favored routes.

In any one or more of the above described methods, the generating comprises changing a route to include at least part of a user-favored route.

A navigation device comprises a global navigation satellite system, implemented at least in part in hardware, configured to determine a position of the navigation device; a user-favored route based route identification module configured to receive a request for a route between a start location and a destination location, identify one or more user-favored routes of a user of the navigation device, and generate, based on the start location, the destination location, and the one or more user-favored routes, a route between the start location and the destination location; and a colloquial instruction generation module configured to identify, by analyzing the route, colloquial navigation instructions describing at least part of the route, and play back the colloquial navigation instructions audibly as the user travels along the route.

In the above described navigation device, the navigation device further comprising a user input module configured to receive a user input indicating that a particular route is favored by the user, and the user-favored route based route identification module being further configured to save, in response to the user input, an indication that the particular route is a user-favored route of the user.

In any one or more of the above described navigation devices, the user-favored route based route identification module being further configured to: automatically determine that a particular route is favored by the user; and save, in response to the user input, an indication that the particular route is a user-favored route of the user.

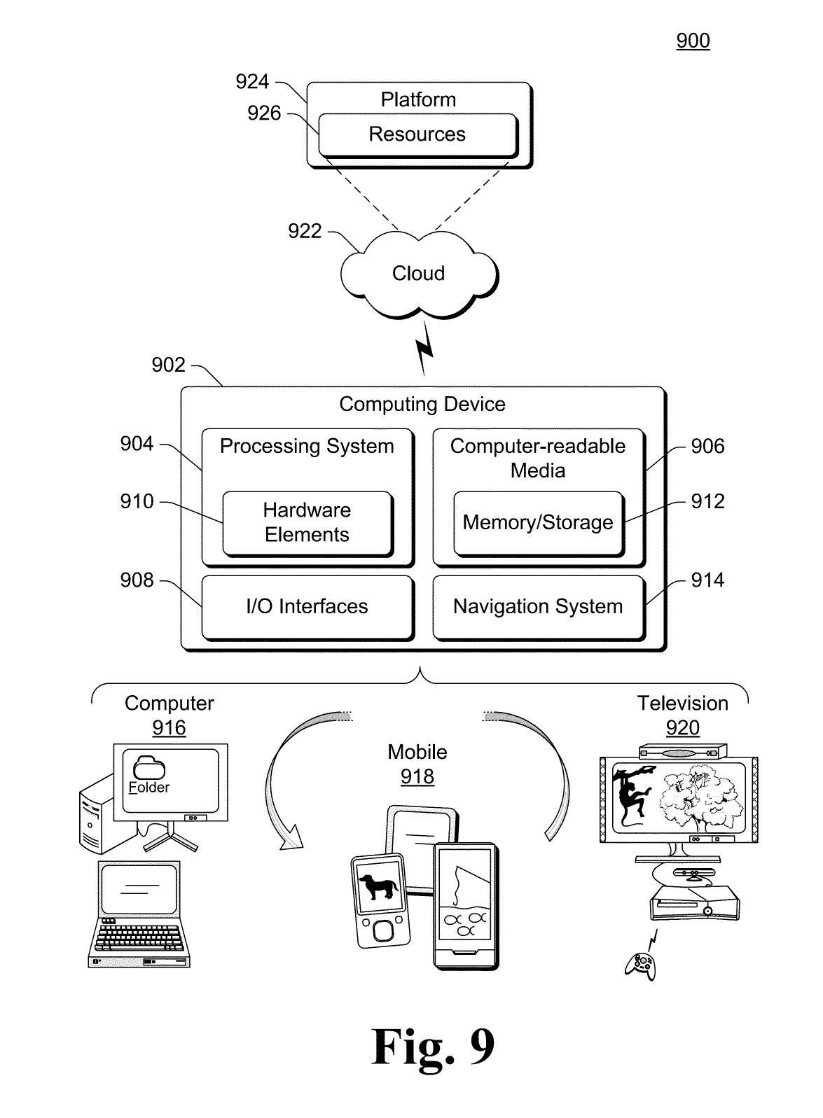

FIG. 9 illustrates an example system generally at 900 that includes an example computing device 902 that is representative of one or more systems and/or devices that may implement the various techniques described herein. The computing device 902 may be, for example, a server of a service provider, a device associated with a client (e.g., a client device), an on-chip system, and/or any other suitable computing device or computing system. The computing device 902 can be, for example, a navigation device 100 of FIG. 1.

The example computing device 902 as illustrated includes a processing system 904, one or more computer-readable media 906, and one or more I/O Interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 902 may be configured in a variety of ways as further described below to support user interaction.

Computing device 902 also includes a navigation system 914. Navigation system 914 provides various navigation and guidance functionality as discussed herein. Navigation system 914 can be, for example, navigation system 106 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of modules as a module that is executable by the computing device 902 as software may be achieved at least partially in hardware, e.g., through use of computer-readable storage media and/or hardware elements 910 of the processing system. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 902 may assume a variety of different configurations, such as for computer 916, mobile 918, and television 920 uses. Each of these configurations includes devices that may have generally different constructs and capabilities, and thus the computing device 902 may be configured according to one or more of the different device classes. For instance, the computing device 902 may be implemented as the computer 916 class of a device that includes a personal computer, desktop computer, a multi-screen computer, laptop computer, netbook, and so on.

The computing device 902 may also be implemented as the mobile 918 class of device that includes mobile devices, such as a mobile phone, portable music player, portable gaming device, a tablet computer, a multi-screen computer, and so on. The computing device 902 may also be implemented as the television 920 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 922 via a platform 924 as described below.

The cloud 922 includes and/or is representative of a platform 924 for resources 926. The platform 924 abstracts underlying functionality of hardware (e.g., servers) and software resources of the cloud 922. The resources 926 may include applications and/or data that can be utilized while computer processing is executed on servers that are remote from the computing device 902. Resources 926 can also include services provided over the Internet and/or through a subscriber network, such as a cellular or Wi-Fi network.

The platform 924 may abstract resources and functions to connect the computing device 902 with other computing devices. The platform 924 may also serve to abstract scaling of resources to provide a corresponding level of scale to encountered demand for the resources 926 that are implemented via the platform 924. Accordingly, in an interconnected device embodiment, implementation of functionality described herein may be distributed throughout the system 900. For example, the functionality may be implemented in part on the computing device 902 as well as via the platform 924 that abstracts the functionality of the cloud 922.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a navigation device, the method comprising:
generating a route between a start location and a destination location;
identifying, by analyzing the route, colloquial navigation instructions describing at least part of the route, the colloquial navigation instructions identifying a number of blocks in situations in which locations of roads along the route correspond to city blocks; and
presenting the colloquial navigation instructions.

2. A method as recited in claim 1, the identifying further including:
analyzing the route to identify map-related features along the route; and
identifying the colloquial navigation instructions based at least in part on the map-related features.

3. A method as recited in claim 2, the map-related features comprising the locations of roads, the analyzing including determining based on the locations of roads that the locations of roads along a particular part of the route correspond to city blocks, and the colloquial navigation instructions identifying a number of blocks until a turn is to be made.

4. A method as recited in claim 2, the map-related features comprising locations of stoplights, and the colloquial navigation instructions identifying a number of stoplights until a turn is to be made.

5. A method as recited in claim 2, the map-related features comprising one or more features selected from the following: locations of bodies of water, locations of bridges, locations of driveways, locations of buildings, locations of off-ramps, and locations of on-ramps.

6. A method as recited in claim 1, the identifying further including:
analyzing the route to identify one or more landmarks along the route; and
identifying the colloquial navigation instructions based at least in part on the landmarks along the route.

7. A method as recited in claim 6, the one or more landmarks including a global landmark known to people familiar with the geographic area that includes the route.

8. A method as recited in claim 6, the one or more landmarks including a personal landmark known to a user of the navigation device despite not being generally known by people familiar with the geographic area that includes the route.

9. A method as recited in claim 1, the presenting the colloquial navigation instructions comprising playing back the colloquial navigation instructions audibly, and the method further comprising:
displaying a visual aid on a map that includes the route, the visual aid being an indication of one or more characteristics of a structure referred to in a colloquial navigation instruction.

10. A method as recited in claim 9, the displaying the visual aid comprising displaying a structure on the map with a color of the structure as indicated by the one or more characteristics of the structure.

11. A method as recited in claim 1, the generating the route comprising:
identifying one or more user-favored routes of a user of the navigation device; and
generating, based on the start location, the destination location, and the one or more user-favored routes, a route between the start location and the destination location.

12. A method implemented in a navigation device, the method comprising:
receiving a request for a route between a start location and a destination location;
identifying one or more user-favored routes of a user of the navigation device;
generating, based on the start location, the destination location, and the one or more user-favored routes, a route between the start location and the destination location; and
presenting navigation instructions for the route.

13. A method as recited in claim 12, the navigation instructions comprising colloquial navigation instructions, and the presenting comprising playing back the colloquial navigation instructions audibly.

14. A method as recited in claim 12, further comprising:
receiving a user input indicating that a particular route is favored by the user; and
saving, in response to the user input, an indication that the particular route is a user-favored route of the user.

15. A method as recited in claim 12, further comprising:
automatically determining that a particular route is favored by the user; and
saving, in response to the user input, an indication that the particular route is a user-favored route of the user.

16. A method as recited in claim 12, the generating comprising:
identifying multiple different routes between the start location and the destination location; and
selecting, as the route between the start location and the destination location, one of the multiple different routes having a largest number of parts in common with one of the one or more user-favored routes.

17. A method as recited in claim 12, the generating comprising changing a route to include at least part of a user-favored route.

18. A navigation device comprising:
a global navigation satellite system, implemented at least in part in hardware, configured to determine a position of the navigation device;
a user-favored route based route identification module configured to
receive a request for a route between a start location and a destination location,
identify one or more user-favored routes of a user of the navigation device, and
generate, based on the start location, the destination location, and the one or more user-favored routes, a route between the start location and the destination location; and
a colloquial instruction generation module configured to
identify, by analyzing the route, colloquial navigation instructions describing at least part of the route, and
play back the colloquial navigation instructions audibly as the user travels along the route.

19. A navigation device as recited in claim 18, the navigation device further comprising a user input module configured to receive a user input indicating that a particular route is favored by the user, and the user-favored route based route identification module being further configured to save, in response to the user input, an indication that the particular route is a user-favored route of the user.

20. A navigation device as recited in claim 18, the user-favored route based route identification module being further configured to:
automatically determine that a particular route is favored by the user; and
save, in response to the user input, an indication that the particular route is a user-favored route of the user.
